(19) United States
(12) Patent Application Publication
(10) Pub. No.: US 2016/0214569 A1
(43) Pub. Date: Jul. 28, 2016

(54) Retractor with Gimbaled Vehicle Sensor

(71) Applicant: KEY SAFETY SYSTEMS INC., Sterling Heights, MI (US)

(72) Inventors: Luis Cendejas, Rochester Hills, MI (US); Rudi Grzic, Sterling Heights, MI (US); Luis Nunez, Mount Clemens, MI (US); Sanjay Vakil, Troy, MI (US)

(73) Assignee: Key Safety Systems, Inc., Sterling Heights, MI (US)

(21) Appl. No.: 14/915,576

(22) PCT Filed: Sep. 10, 2014
(86) PCT No.: PCT/US2014/054943

§ 371 Date: Feb. 29, 2016

Related U.S. Application Data
(60) Provisional application No. 61/877,516, filed on Sep. 13, 2013.

(51) Int. Cl. B60R 22/40

(52) U.S. Cl. CPC B60R 22/40; B60R 2022/402

(57) ABSTRACT

A seat belt retractor comprising a gimbaled vehicle sensor (100) having a gimbal (160) rotationally movable relative to a housing (120) fixed to a portion of the retractor, the retractor including a force generator (70) generating a radial force which upon movement of the gimbal creates a tangential torque to slow or damp the motion of the gimbal relative to the housing.

### BACKGROUND AND SUMMARY OF THE INVENTION

The present invention generally relates to seat belt retractors and more specifically to a seat belt retractor having a gimbaled vehicle sensor.

FIG. 1 illustrates a rudimentary vehicle sensor 20 comprising a stationary basket 22 fixed to the retractor frame, a mass such as a ball 24 movable on the basket and a sensor pawl 26 rotationally movable about a pivot 28. Pawl 26 includes an engagement tip 29. As the vehicle in which the retractor is mounted accelerates and decelerates as indicated by arrows 30 and 32 the ball 24 will move upon basket 22 lifting pawl 26 into engagement with teeth 34 of the ratchet wheel 36, only a portion of which is shown. A properly designed vehicle sensor is one that will cause pawl 26 to engage the ratchet wheel 36 during an emergency but will not cause spurious engagements such as caused by minor vehicle acceleration or deceleration during braking.

In many vehicles the seat belt retractor is mounted to the back of the vehicle seat. Provision must be made to maintain the basket in a generally vertical position as the seat back is moved through its range of motion. To accommodate this need, gimbaled vehicle sensors have been developed. In general a gimbaled vehicle sensor is one in which the basket can rotate about an axis 40 to maintain an axis perpendicular to the basket in alignment with the local vertical. Reference is made to FIG. 2 which diagrammatically illustrates a prior art gimbaled sensor and to FIG. 4 which illustrates features of a gimbaled sensor as well as a component of the present invention. In general a gimbaled vehicle sensor positions mass 42 at a lever arm 44 from the basket 22, the basket 22 is formed as a center portion of a gimbal or rotatable frame 50, having opposing stub axles 52 which are aligned with axis 54. Each stub axle is received within a bushing 56 which is part of the housing, not illustrated in FIG. 2 or 4, which is secured to the frame of the seat belt retractor. As the vehicle seat back is moved it carries the retractor with it, mass 42 will tend to align the pivoted gimbal 50 with vertical, maintaining the basket 22 and mass or ball 24 in the desired orientation.

More specifically the invention comprises: a seat belt retractor comprising a gimbaled vehicle sensor having a gimbal 160 rotationally movable relative to a housing fixed to a portion of the retractor, the retractor including a force generator generating a force which upon movement of the gimbal creates a torque on the axles or axle to slow or damp the motion of the gimbal relative to the housing. In one embodiment, the force generator comprises a member capable of generating a force that acts perpendicular to the axis of rotation of the gimbal. The gimbal includes a stub axle of a fixed diameter and further includes a concentric disk having a greater diameter, wherein the force generator acts upon the concentric disk. In the preferred embodiment of the invention the force generator comprises a length of spring steel with an engagement end that is one of curved or flat. Other embodiments are shown and described.

### BRIEF DESCRIPTION OF THE DRAWINGS

FIG. 1 illustrates a prior art vehicle sensor.

FIG. 2 diagrammatically illustrates a prior art gimbaled vehicle sensor.

FIG. 3 diagrammatically illustrates the operation of the present invention.

FIG. 4 diagrammatically illustrates the major components of the present invention.

FIG. 5 is an enlarged view of a portion of FIG. 4.

FIGS. 6 and 7 show alternate embodiments of the invention.

FIG. 8 shows an isolated view of a gimbaled vehicle sensor in accordance with the present invention.

FIG. 9 shows a side view of the present invention.

FIG. 10 is an exploded view of the present invention.

FIG. 11 is an enlarged portion of the vehicle sensor of the present invention.

FIG. 12 shows a seat belt retractor with the gimbaled vehicle sensor.

FIGS. 13 and 14 show other embodiments of the invention.

### DETAILED DESCRIPTION OF THE DRAWINGS

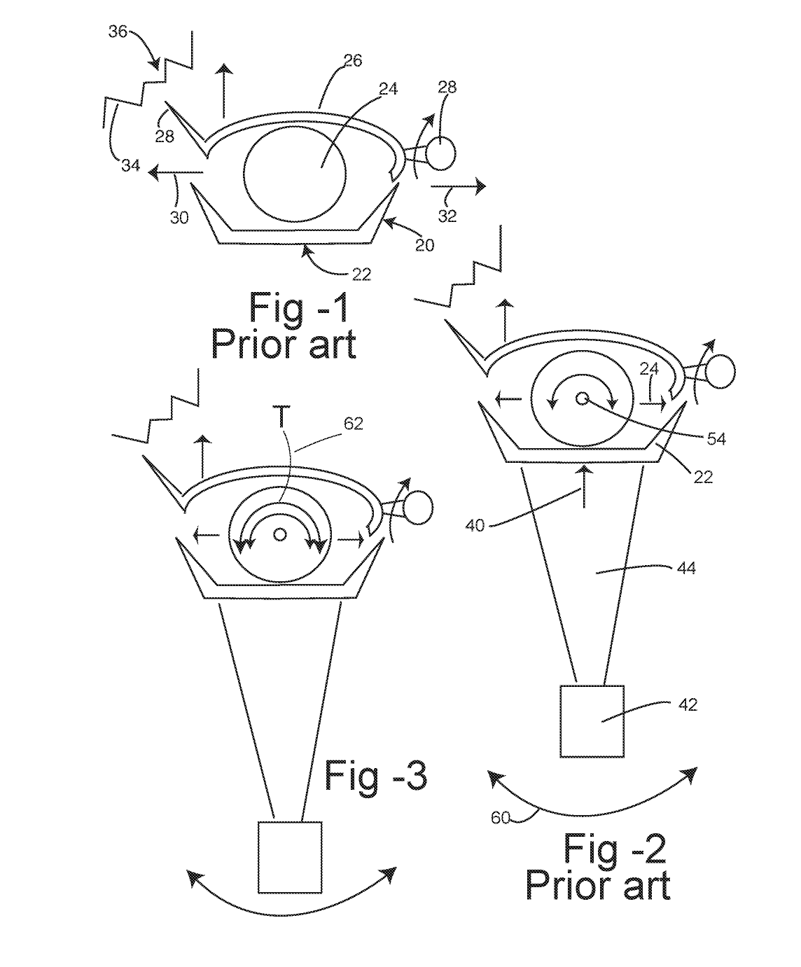

Reference is again made to FIG. 2 which illustrates an operational state of the prior art gimbaled vehicle sensor. If the vehicle in which this sensor is mounted decelerates, this mass 24 will move to the right, in FIG. 2 and simultaneously the lower mass 42 will rotate to the right along arc 60. This compound motion for a given acceleration and a similar motion for deceleration will tend to place the bowl 22 closer to pawl 26 than might occur with the stationary vehicle sensor as illustrated in FIG. 1. The result of this compound motion increases the probability of a lock of the seat belt retractor thereby creating a nuisance or annoyance to the wearer of the seat belt, such a situation is often referred to as a nuisance lock. FIG. 3 illustrates the principle of the present invention as applied to a prior art vehicle sensor, if it were possible to create a retarding torque T or 62; this would tend to reduce the motion and the level of swing of basket 22 during these dynamic conditions which reduces the possibility of nuance lock.

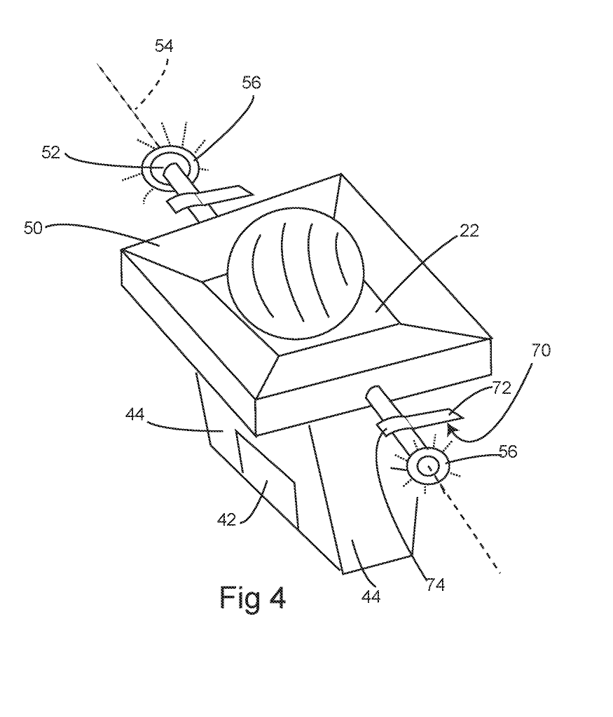

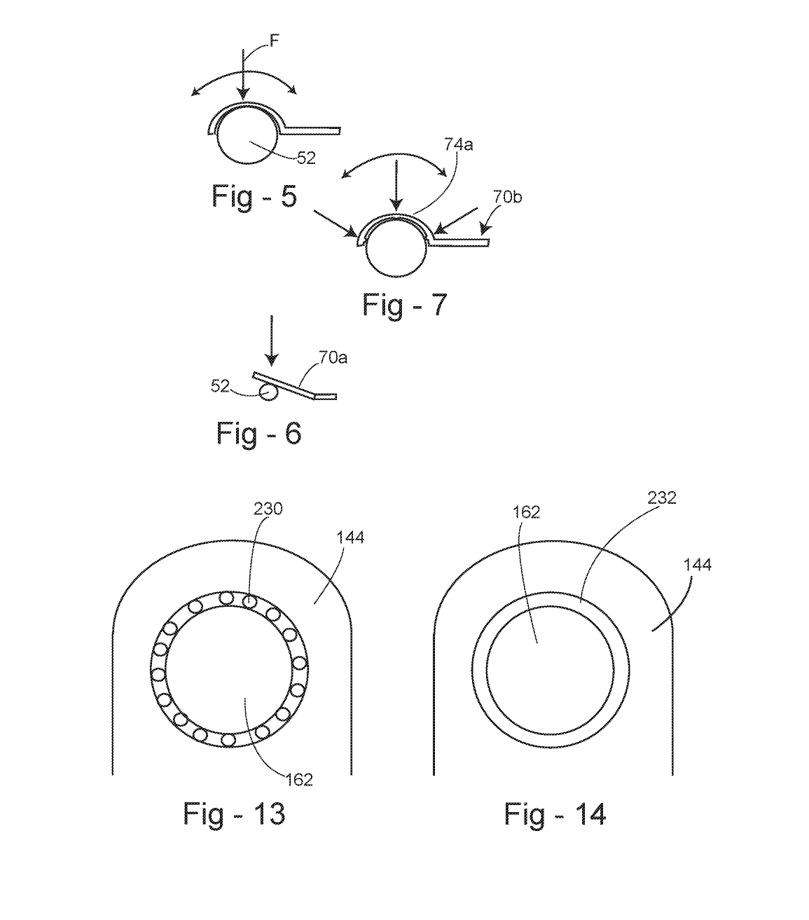

Reference is again made to FIG. 4 which illustrates one means of generating the torque 62; this means comprises at least one engagement arm or force generator 70, two are shown, formed of a length of spring steel having a mounting arm 72 and an engagement end 74. As illustrated in FIGS. 4 and 5, the engagement end 74 is curved and loads axle 52 with a known force F. FIG. 6 illustrates an alternative embodiment in which the engagement arm 70a is generally straight. In both FIGS. 5 and 6 the engagement arm contacts axle 52 at a tangent point. FIG. 7 illustrates an embodiment of engagement arm 70b in which the engagement end 74a is curved but contacts axle 52 at multiple points. In each case the radial or normal forces create a frictional torque to retard the motion of the axle, gimbal or basket.

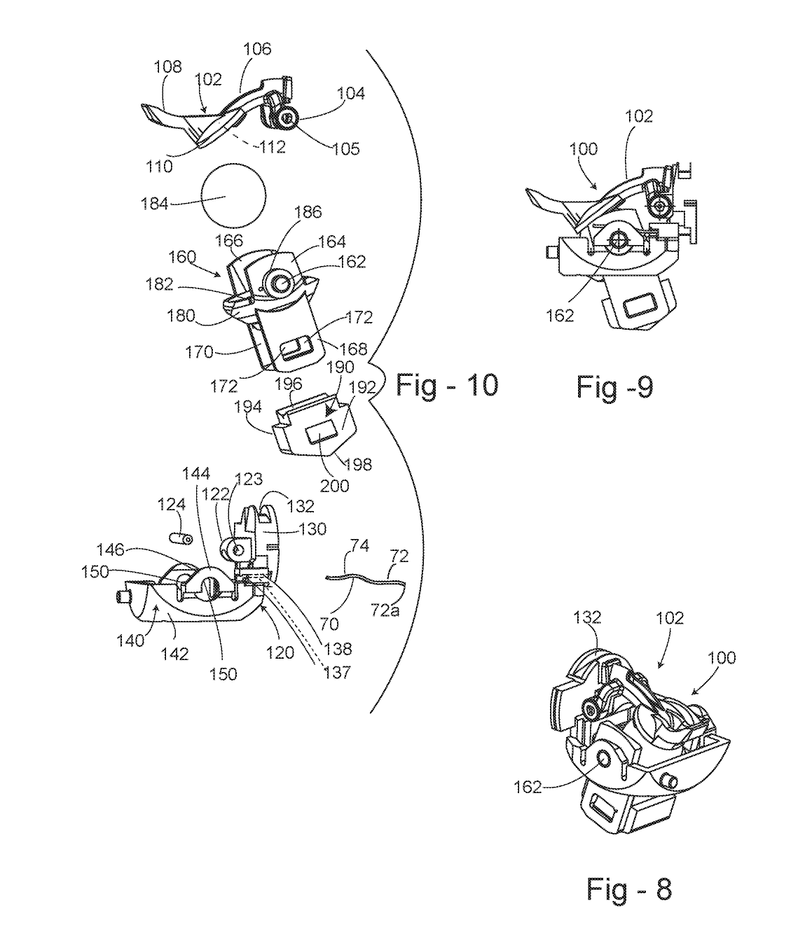

Reference is made to FIGS. 8-10 which illustrate major components of the present invention. The vehicle sensor 100 comprises a sensor pawl 102 having a sensor arm 106 pivoted about a hinge component 104, the sensor arm terminates in a tooth 108. Extending from an underside of arm 106 is a cap 110 that has a concave undersurface 112. The tooth 108 is adapted to engage the teeth 34 of the toothed wheel 36. Hinge component 104 is adapted to mate with the hinge component 122 of the housing 120. Hinge component 104 including two legs 104a and 104b each of which includes an aligned opening 105. Hinge component 122 includes a stub, projection or axle 122a with an opening 123. Legs 104a and 104b are received about stub 122a and a pin 124 extends through the various openings and completes the hinge.

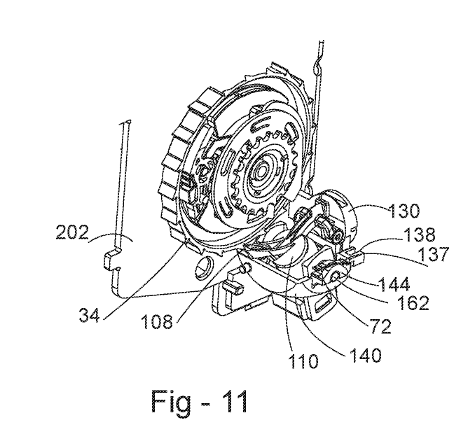

The housing 120 includes an upper housing part 130 having a slot 132 adapted to fit within a mating portion of the retractor frame. The housing also includes a lower housing part 140 comprising a lower basket 142 and a plurality of arched members 144 and 146; each of the arched members 144 and 146 includes an opening 150 which functions as a bushing to receive a respective one of the stub axles 162 of the gimbal 160. Gimbal 160 includes a first and second upraised plate 164 and 166. One of the stub axles 162 extends from each of the plates 164 and 166; only one stub axle is illustrated in FIG. 10. The gimbal 160 also includes two lower extending plates 168 and 170 each of which includes an oblong opening 172. The basket 180 which supports a spherical mass 184 is suspended across the plates 164 and 166. The basket 180 has a concave inner surface 182 which permits the mass 184 to roll thereon. Gimbal 160 further includes a projection or disk 186 that is circular in shape and concentric with stub axle 162. As illustrated one such disk 186 is associated with plate 164. Another disk 186 can be positioned and associated with plate 166. As mentioned above the present invention also includes the engagement arm 70 with its mounting arm 72 and engagement end 74. The distal end 72a of the mounting arm is received in a slit 137 of a retainer 138 attached proximate the first housing part 130, shown in detail in FIG. 11.

The plates 168 and 170 are adapted to hold a second mass 190. As illustrated the mass 190 includes two flat parallel sides 192 and 194, which fit against the flat sides of plates 168 and 170, a top 196 and a bottom 198, which is generally conical shaped. Extending from each side 192 and 194 respectively is a tapered projection 200 adapted to snap fit into the openings 172 of plates 168 and 170 which move apart slightly as the mass 190 is inserted. When assembled as shown in FIGS. 8 and 9 the gimbal 160 via its stub axles 162 can rotate with regard to the bushings 150 of the lower housing member 140. In a steady state the axis extending through the stub axle also extends through the mass 184.

In operation the orientation of the retractor changes with the orientation of the seat back; the sensor housing 120 will move with the retractor. The gimbal 160 is free to move as the stub axles 162 rotate about the bushings 150 in view of the gravity bias resulting from mass 190. The mass 190 will tend to maintain the verticality of gimbal 160. Engagement arm 72 generates a compressive force on the stub axle 162; as mentioned there could be one or two engagement arms depending upon need and space. As the stub axle rotates this compressive force will generate a tangential motion sensitive torque tending to slow or damp the rotation of the gimbal 160 relative to the housing 120. The activation arm acts on the larger diameter surface of the circular projection or disk 186 which generates a greater torque than if the activation arm operated on the smaller diameter stub axle. During an emergency situation the mass 184 will move upon the inner surface 182 of the basket 180 and engaging cap 110 causing tooth 108 to engage one of the teeth 34 to initiate the locking of the retractor as shown below.

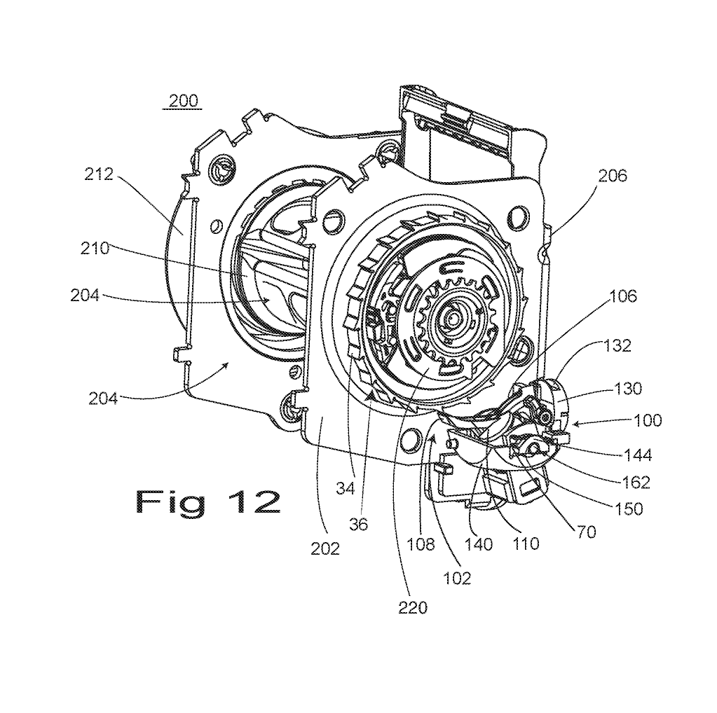

Reference is briefly made to FIG. 12 which illustrates a seat belt retractor 200a including the above described gimbaled vehicle sensor 100. The retractor includes a frame 203 having a frame first side 202, a second frame side 202a and a back frame side 206. The gimbaled sensor 100 is mounted to the first frame side 202 of the retractor. The side frames rotationally support a spool 210 upon which is wound a length of seat belt webbing. A rotational spring, not shown, is mounted within a spring housing 212 and acts upon one end of the spool. The spring housing is mounted to side frame 202a. A locking mechanism 220 which includes a vehicle web sensor 221 is mounted to side frame 202 and includes ratchet wheel 36. This locking mechanism is relatively conventional. In response to a vehicle deceleration which would typically be greater than 0.45 g the spherical mass 184 lifts arm 106 bringing the tooth 108 into engagement with tooth 34 of the ratchet wheel 36, which brings into motion the locking mechanism preventing the rotation of spool 210 and extension of the seat belt.

Reference is briefly made to FIGS. 13 and 14 which illustrate alternate embodiments of the invention. In these embodiments the force generator 70 comprising the spring steel element is replaced in FIG. 13 with a bearing 230 designed to generate the required opposing motion sensitive torque. This bearing 230 can be a ball bearing or bearing configured to have an inner and outer race with for example silicate powder captured therebetween which will generate a damping torque of approximately 1-3 Newtons. The inner race supports shaft 262 and the outer race is connected to the arched member 144. In FIG. 14, the bearing 230 is replaced with a friction surface 232 configured to generate a torque in opposition to the motion of the shaft 262.

Many changes and modifications in the above-described embodiment of the invention can, of course, be carried without departing from the scope thereof. Accordingly, that scope is intended to be limited only by the scope of the appended claims.

1. A seat belt retractor comprising a gimbaled vehicle sensor (100) having a gimbal (160) rotationally movable relative to a housing (140) fixed to a portion of the retractor, the retractor including a force generator (70) generating a radial force which upon movement of the gimbal (160) creates a tangential torque to slow or damp the motion of the gimbal relative to the housing (140).

2. The retractor according to claim 1 wherein the force generator (70) comprises a member capable of generating a force that acts perpendicular to an axis of rotation of gimbal (160).

3. The retractor according to claim 2 wherein the gimbal includes a pair of stub axles (162) of a fixed diameter and each stub axle further includes a concentric disk (186) having a greater diameter and wherein the force generator acts upon the concentric disk (186).

4. The retractor according to claim 2 wherein the force generator comprises a length of spring steel with a mounting arm (72) and an engagement end (74) that is one of curved or flat.

5. The retractor according to claim 4 wherein the engagement arm (74) contacts the axle (52) at a tangent point.

6. The retractor according to claim 4 wherein the engagement arm (74) is curved and contacts the axle (52) at multiple tangent points.

7. The retractor according to claim 5 wherein the engagement arm (74) applies a radial or normal force to create a frictional torque to retard motion of the axle, gimbal or basket.

8. The retractor according to claim 6 wherein the engagement arm (74) applies a radial or normal force to create a frictional torque to retard motion of the axle, gimbal or basket.

9. The retractor according to claim 3 wherein the housing (140) is a lower housing part (140) comprising a lower basket (142) and a plurality of arched members (144 and 146), each of the arched members (144 and 146) includes an opening (150) which functions as a bushing to receive a respective one of the stub axles (162) of the gimbal (160).

10. The retractor according to claim 9 wherein gimbal (160) includes a first and second upraised plate (164 and 166), one of the stub axles (162) extends from each of the plates (164 and 166).

11. The retractor according to claim 10 wherein the gimbal (160) also includes two lower extending plates (168 and 170) each of which includes an oblong opening (172), and the basket (180) which supports a spherical mass (184) is suspended across the plates (164 and 166).

12. The retractor according to claim 11 wherein the basket (180) has a concave inner surface (182) which permits the mass (184) to roll thereon.

13. The retractor according to claim 12 wherein gimbal (160) further includes a projection or disk (186) that is circular in shape and concentric with stub axle (162), one such disk (186) is associated with plate (164), another disk (186) can be positioned and associated with plate (166).

14. The retractor according to claim 13 wherein distal end (72a) of the mounting arm (72) is received in a slit (137) of a retainer (138) attached proximate a first upper housing part (130).

15. The retractor according to claim 14 wherein plates (168 and 170) are adapted to hold a second mass (190), the mass (190) includes two flat parallel sides (192 and 194), which fit against the flat sides of plates (168 and 170), a top (196) and a bottom (198), which is generally conical shaped, extending from each side (192 and 194) respectively is a tapered projection (200) adapted to snap fit into openings (172) of plates (168 and 170) which move apart slightly as the mass (190) is inserted.

16. The retractor according to claim 15 wherein when assembled, the gimbal (160) via its stub axles (162) can rotate with regard to the bushings (150) of the lower housing member (140), in a steady state the axis extending through the stub axle also extends through the mass (184).

17. The seat belt retractor (200a) including the gimbaled vehicle sensor (100) of claim 11 further comprises a frame (203) having a frame first side (202), a second frame side (202a) and a back frame side (206), the gimbaled sensor (100) is mounted to the first frame side (202) of the retractor, wherein the frames first and second sides rotationally support a spool (210) upon which is wound a length of seat belt webbing and in response to a vehicle deceleration which would typically be greater than 0.45 g the spherical mass (184) lifts arm (106) bringing a tooth (108) into engagement with a tooth (34) of a ratchet wheel (36), which brings into motion a locking mechanism preventing the rotation of spool (210) and extension of the seat belt.

18. The retractor according to claim 1 wherein the force generator (70) comprising a bearing (230) designed to generate the required opposing motion sensitive torque, the bearing (230) can be a ball bearing or bearing configured to have an inner and outer race with silicate powder captured therebetween which will generate a damping torque of approximately 1-3 Newtons.

19. The retractor according to claim 18 wherein the inner race supports shaft (262) and the outer race is connected to the arched member 144.

20. The retractor according to claim 1 wherein the force generator (70) further comprises friction surface (232) configured to generate a torque in opposition to the motion of the shaft (262).
